(19) United States
(12) Patent Application Publication
(10) Pub. No.: US 2007/0081131 A1
(43) Pub. Date: Apr. 12, 2007

(54) Rotatable projection lens for rear-projection applications

(75) Inventors: Antonius Gerardus Cornelis Van Der Palen, Veldhoven (NL); Tieying Ding, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/582,379

(22) PCT Filed: Dec. 13, 2004
(86) PCT No.: PCT/IB04/52783

§ 371 Date: Jun. 9, 2006

Related U.S. Application Data
(60) Provisional application No. 60/529,791, filed on Dec. 16, 2003.

(51) Int. Cl. G03B 3/00; H04N 5/74

(52) U.S. Cl. 353/101; 348/781

(57) ABSTRACT

An optical system for a projection display device includes a first lens group having a first optic axis and a second lens group having a second optic axis, wherein the second lens group is adapted to rotate about the first optic axis. Alternatively, the optical system includes a first optic axis, and a lens group having a second optic axis, wherein the lens group is adapted to rotate about the first optic axis.

Projection display devices are used in a variety of applications. Liquid crystal (LC) technology has been applied in projection displays for use in projection televisions and electronic cinema to mention a few applications.

In known rear-projection applications, a rear surface mirror, or rear fold mirror is used to project an image from an LC panel and projection optics onto a display surface or a screen. The elements of the display device, including the LC panel, projection optics and mirrors are housed in a cabinet, with one surface of the cabinet having the display surface for viewing.

Unfortunately, the cabinets for these rear projection devices are relatively large. Moreover, known LC-projection optics combinations are not readily adapted in all cabinets. As to the former, it is desirable to reduce the depth and height of the cabinet However, this is rather difficult due to the rather inflexible designs of the LC projection optics. As to the latter, properly locating a projection optical system in a cabinet having a comparatively reduces depth may require an increase in cabinet height, for example to accommodate the projection lens so proper function is achieved.

In accordance with an example embodiment, an optical system for a projection display device includes a first lens group having a first optic axis and a second lens group having a second optic axis, wherein the second lens group is adapted to rotate about the first optic axis.

In accordance with another example embodiment, an optical system for a projection display device includes a first optic axis, and a lens group having a second optic axis, wherein the lens group is adapted to rotate about the first optic axis.

The invention is best understood from the following detailed description when read with the accompanying drawing figures. It is emphasized that the various features are not necessarily drawn to scale. In fact, the dimensions may be arbitrarily increased or decreased for clarity of discussion.

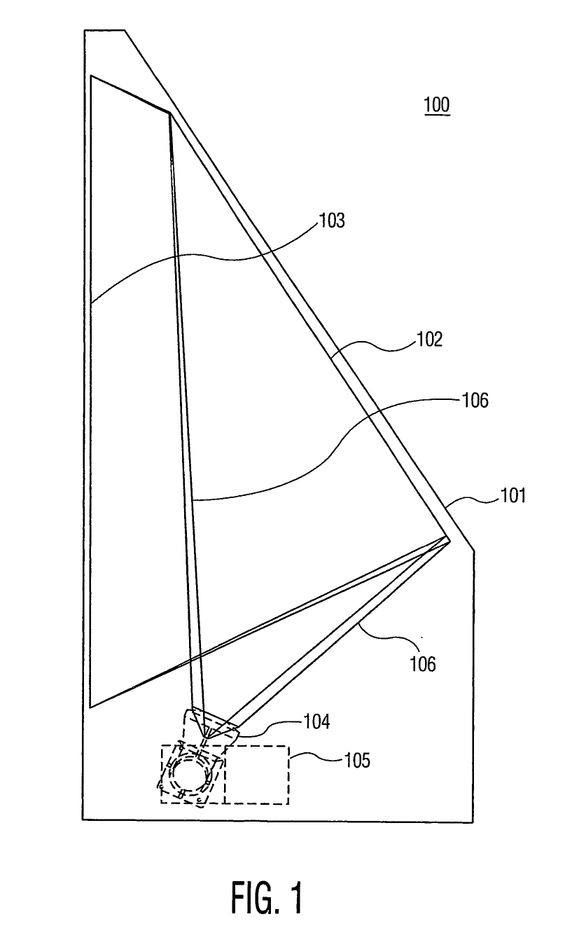

FIG. 1 is a cross-sectional view of an LCD projection display device including a cabinet in accordance with an example embodiment;

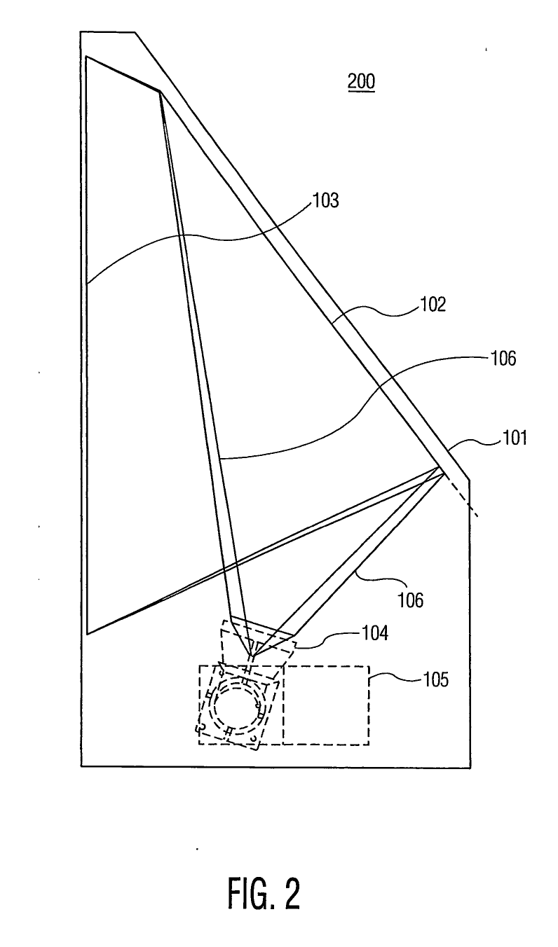

FIG. 2 is a cross-sectional view of an LCD projection display device including a cabinet in accordance with an example embodiment;

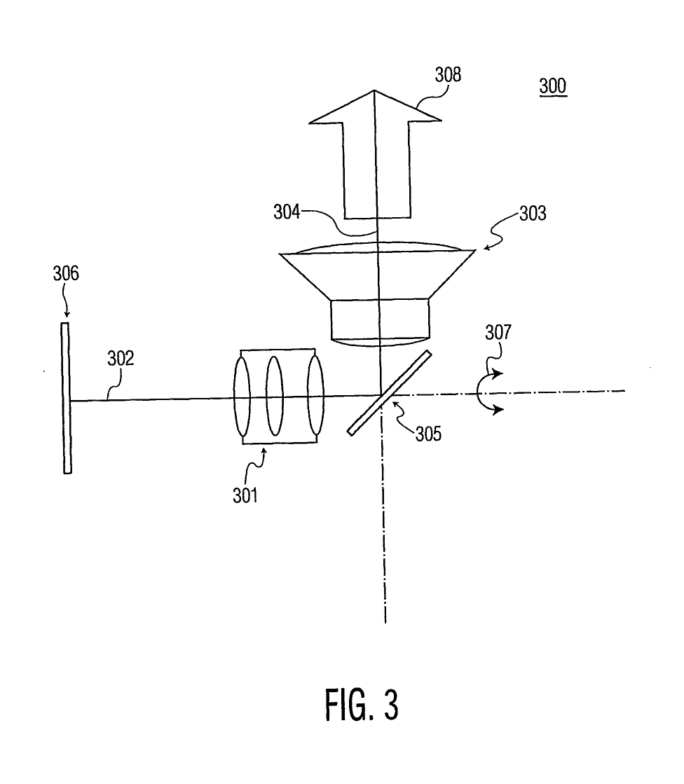

FIG. 3 is a schematic view of a projection optical system and display panel in accordance with an example embodiment;

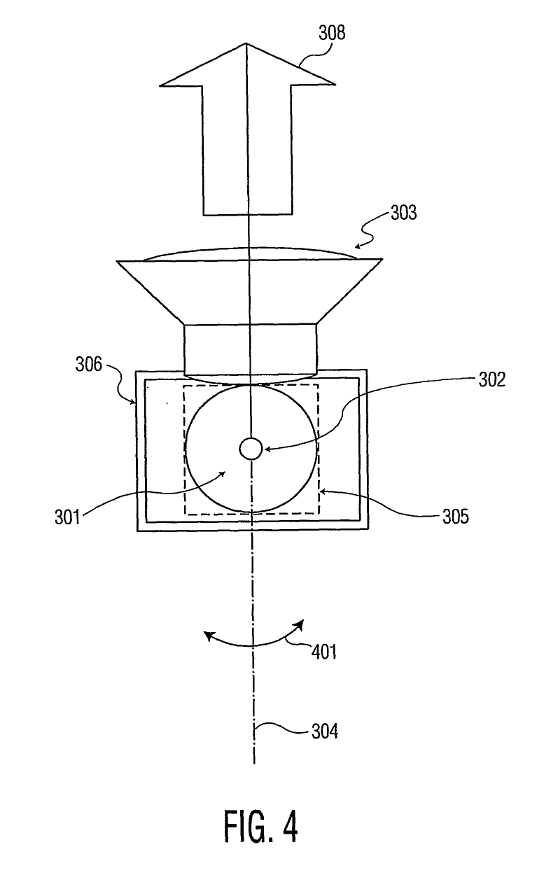

FIG. 4 is a schematic view of the projection optical system and display panel of FIG. 1 shown from another perspective and in accordance with an example embodiment;

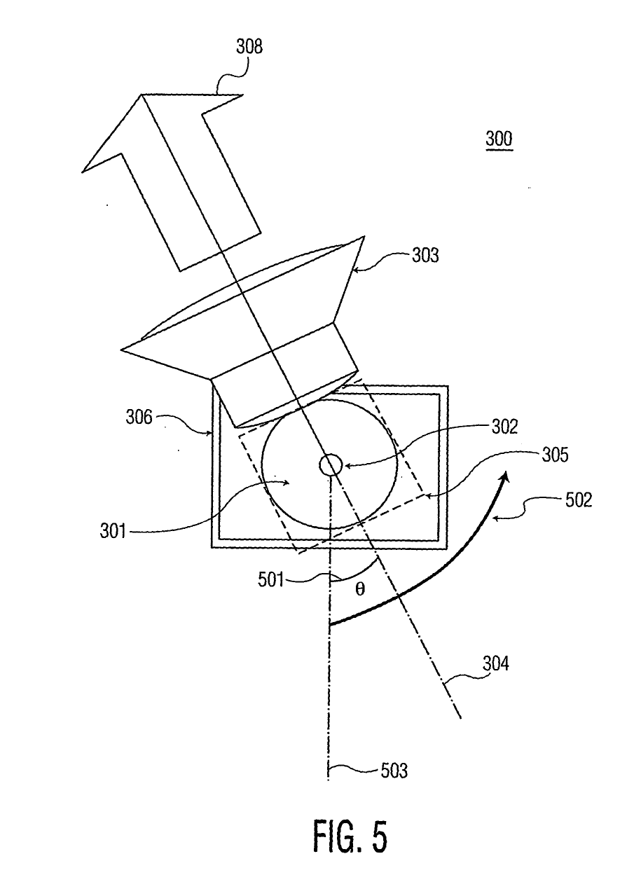

FIG. 5 is a schematic view of the projection optical system and display panel of FIG. 1 shown from another perspective and in accordance with an example embodiment;

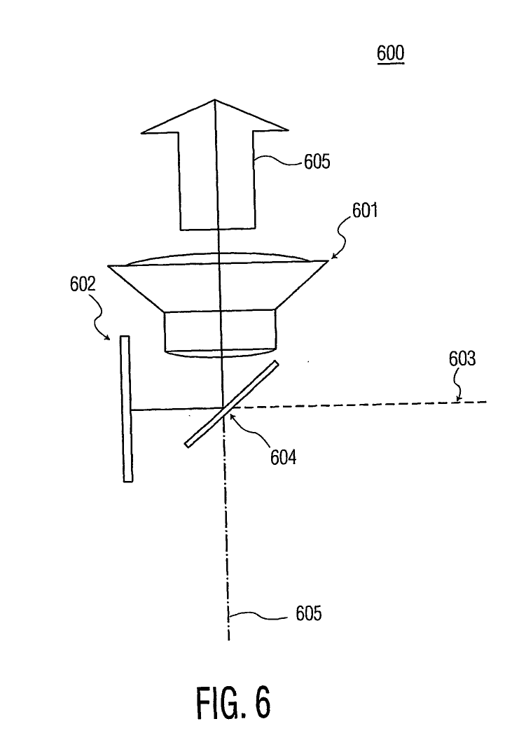

FIG. 6 is a schematic view of the projection optical system and display panel in accordance with an example embodiment;

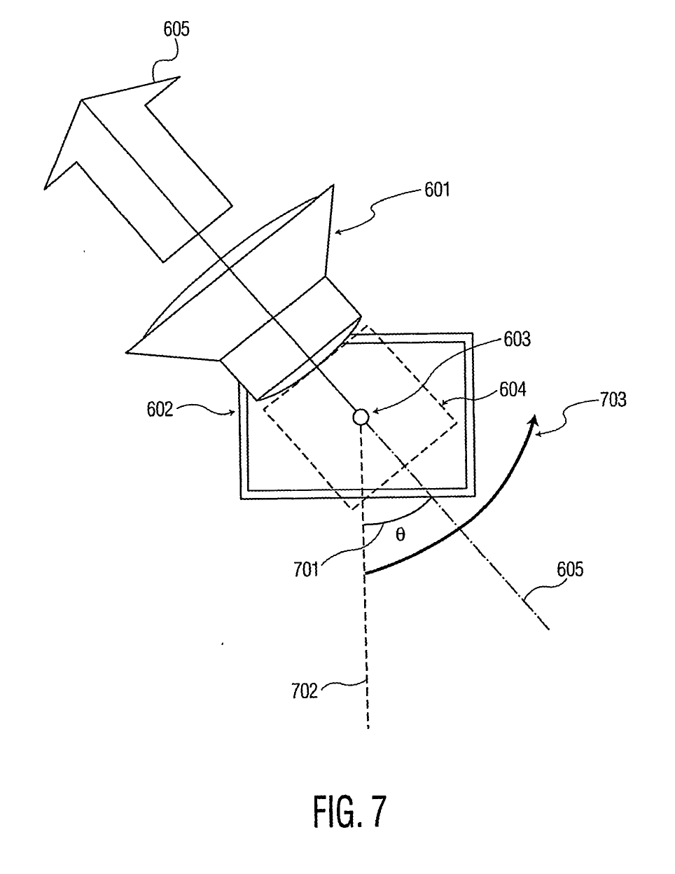

FIG. 7 is a schematic view of the projection optical system and display panel of FIG. 6 shown from another perspective and in accordance with an example embodiment;

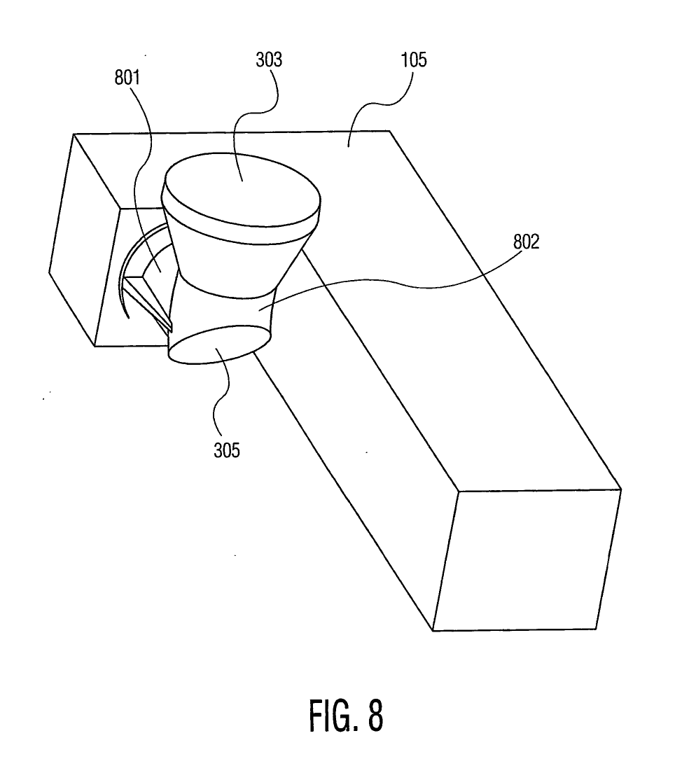

FIG. 8 is a perspective view of a projection optical system connected to a base in accordance with an example embodiment; and

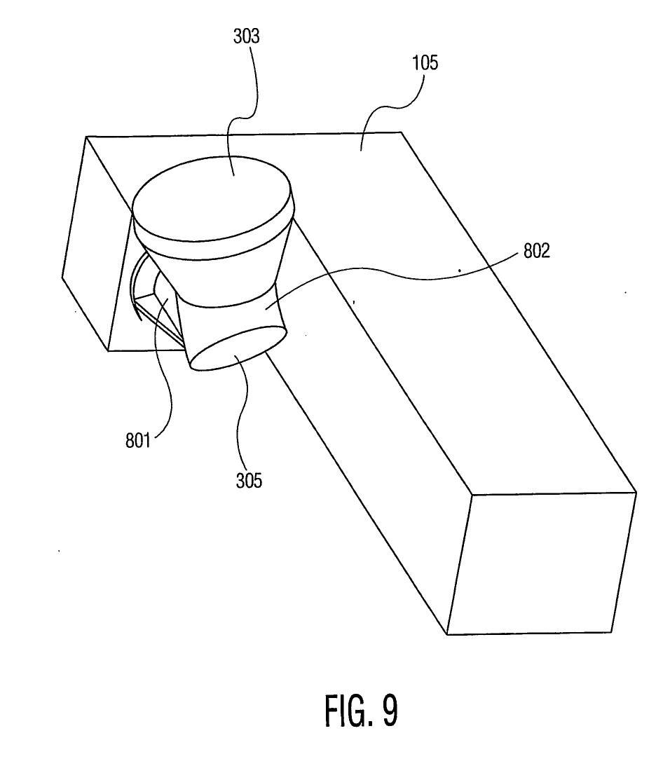

FIG. 9 is a perspective view of a projection optical system connected to a base in accordance with an example embodiment.

In the following detailed description, for purposes of explanation and not limitation, example embodiments disclosing specific details are set forth in order to provide a thorough understanding of the example embodiments. However, it will be apparent to one having ordinary skill in the art having had the benefit of the present disclosure that other embodiments that depart from the specific details disclosed herein. Moreover, descriptions of well-known devices, methods and materials may be omitted so as to not obscure the description of the present invention. Finally, wherever practical, like reference numerals refer to like features.

Briefly, in accordance with example embodiments, a projection optical system includes a first lens group, a fold mirror and, optionally a second lens group. The first lens group has an optical axis that is orthogonal to the second lens group. The fold mirror is usefully disposed between the first and second lens groups. Moreover, a display device, such as an LC device provides an image to the second lens group. The light from the second lens group is incident on the fold mirror, and then on the first lens group. The fist lens group directs the light image onto a mirror of a rear-projection display device for imaging at a screen. In the example embodiments, the first lens group is adapted to rotate relative to the second lens group. Beneficially this allows the adaptation of image projection to accommodate the cabinets of varying dimensions, and without rotating the entire projection lens assembly, which can be counter-productive to the goal of reducing the height of the cabinet/pedestal of the display device.

FIG. 1 shows a cross-section of a rear projection display device 100 in accordance with an example embodiment. The device 100 includes a cabinet 101, having a mirror or reflective surface 102 in a rear portion thereof, and a display surface or screen 103 at a front surface. The device 100 also includes a projection lens assembly 104, which includes the projection optics and display panel (e.g., LC display panel). The lens assembly also includes a base 105, which may be integral with the lens assembly and display panel. In the example embodiment of FIG. 1, the projection lens assembly focuses an image beam 106 on the mirror 102, which reflects this image onto the screen 103. Illustratively, the screen is 65″ diagonally across its surface, and the dimensions of the cabinet in relative units are as shown.

In order to accommodate the relative orientation and dimensional placement of the display elements selected elements of the projection lens of the projection lens assembly are rotated, without the moving or rotating the base 105. As will become clearer as the present description continues, this ability to provide the projection capability of the projection lens assembly 104 in a variety of different cabinets and displays without having to alter the cabinet is a significant benefit, allowing adaptability of the projection lens assembly 104 in many disparate cabinets and devices.

FIG. 2 shows a cross-section of a rear projection display device 200 having reduced dimensions compared to the device of FIG. 1. To wit, the display screen of the device 200 is 44″, and the other shown (in cm) dimensions are smaller than their counterparts of FIG. 1, otherwise, the cabinet is substantially the same as that of the example embodiment of FIG. 1. However, and as will become clearer as the present description continues, selected elements of the lens assembly are rotated at an angle relative to other elements compared to their angle of rotation in the embodiment of FIG. 1. Moreover, like the embodiments of FIG. 1, the base 105 remains stationary.

FIG. 3 is a schematic view of a projection lens assembly 300 in accordance with an example embodiment. The projection lens assembly 300 includes a first lens group 301 having a first optic axis 302, and a second lens group 303 having a second optic axis 304. A reflective surface 305 is disposed between the first lens assembly 301 and this second lens assembly 303, and usefully at the intersection of the first and second optical axes. A display panel or image 306 emits light for forming the image onto a screen (not shown) in a rear projection display device. The display panel 306 represents the optical assembly of an LCD display device, and the image formed at this point is then focused onto the screen by the projection lens assembly and rear mirror referenced in connection with FIGS. 1 and 2. Illustratively, the display panel may be a liquid crystal on silicon (LCOS) based assembly, a transmissive LC assembly, or other similar structure. Moreover, images from laser displays may be incorporated into a display device in keeping with the example embodiments.

In accordance with an example embodiment, the first optic axis is substantially orthogonal to the second optic axis, and the second lens assembly 303 is adapted to rotate about the first optic axis as shown at 307. It is noted that the assembly is usefully disposed over a base or mount (not shown), and the first lens assembly 301, the display 306, the reflective surface 305 and the second lens assembly 303 are beneficially disposed in cylindrical elements (not shown) to facilitate the stable rotation of the second lens assembly 303.

It is noted that the first and second lens assemblies and the reflective surface are known devices in the art. For example, the second lens assembly 303 may be a projection lens found in rear projection systems. Similarly, the first lens assembly and the reflective element are usefully refractive lenses and a mirrored surface, respectively, which are well within the purview of the ordinarily skilled artisan. In addition to the referenced known elements, other elements may be used for the first and second lens assemblies and the reflective surface. For example, the reflective element 305 may be a dichroic mirror, which transmits light of a certain polarization state.

In operation, light from the display panel 306 is imaged by the first lens assembly 301 onto the reflective surface 305. The reflective surface 305 reflects the light orthogonally to its original direction to the second lens assembly 303, which projects the image 308 onto a rear mirror (e.g., rear mirror 102) or similar projection surface. As such, the image from the display panel 306 is imaged in a rather confined space by the projection lens assembly 300.

FIG. 4 is a schematic view of a projection lens assembly 300 of FIG. 3 from a front view looking down the first optic axis 302 in accordance with an example embodiment. To wit, the schematic view of the assembly in FIG. 4 shows the reflective surface immediately in front, the first lens group 305 behind the lens and the display panel 306 behind the first lens group 301. Moreover, the second lens group 303 is oriented along the second optic axis 304 and thus orthogonal to the first optic axis 303. As will become clearer as the present description continues, the rotation of the second lens group 303 in the direction 401 enables the second lens group 303 to project the image 308 onto projection surfaces in a variety of cabinet devices, in spite of the variation in the size and placement of elements (e.g., a rear mirror, or a screen) from one cabinet to another, and without substantial modification to the cabinet.

FIG. 5 is a schematic view of the projection lens assembly 300 rotated about the first optic axis 302 in keeping with the description. The rotation angle (Θ) 501 shows the degree of rotation 502 of the second lens assembly 303 from the original orientation 503. As can be appreciated, the capability to tailor the degree of rotation at the display manufacturing level affords significant versatility by allowing one projection lens assembly to be implemented in a variety of display devices.

It is noted that in accordance with example embodiments, the rotation of the second lens assembly may be in the direction shown (counterclockwise) or in the opposite direction shown (clockwise). Illustratively, the second lens assembly 303 is rotated about the first optic axis 301 via a mount (e.g., base 105), which is fixed to the cabinet or some other element that is mounted to the system. The rotational action may be by one of a variety of mechanical device, such as ball-bearings in an o-shaped groove. Of course, this is merely illustrative, and it is noted that other mechanical elements may be used to meet this end. Furthermore, the rotational mechanism may also include a coarse movement and a fine movement for selecting the proper angle with precision. Additionally, a locking or securing mechanism may be used to fix the second lens assembly 303 in a desired position. It is noted that the rotation and alignment may be effected before or after the disposition of the projection lens assembly 300 in the cabinet.

In addition to the features of the projection lens assembly of the example embodiments thus described, additional features and variations are noteworthy. In accordance with an example embodiment, a first tube, which has the first optic axis 302 as its center consists of two parts that can be rotated relative to each other. Beneficially, the outside dimension of one part fits into the inside dimension of the other part so that a stable first optic axis is obtained inside the first tube.

In accordance with another example embodiment, the first tube contains no lens elements, and both the first and the second lens assemblies are disposed in the second tube. In accordance with another example embodiment, there are lens elements present in the first tube; In this embodiment, the lens elements are present in the part of the first tube rotates relative to the display panel 306.

Alternatively, in an example embodiment, the second tube contains no lens elements and both the first and the second lens assemblies are disposed only lens elements are present in the first tube. In this embodiment the lens elements are present in the part of the first tube that remains fixed relative to the display panel 306.

In yet another embodiment, the lens elements present in the first tube comprised of two subgroups. A first subgroup (e.g., first lens assembly 301) is part of the first tube that remains fixed relative to the display panel, and the second subgroup (e.g., second lens assembly 303) is part of the first tube that rotates relative to the display panel.

FIG. 6 shows a projection lens assembly 600 in accordance with an example embodiment. In the example embodiment, there is only one lens assembly, namely lens assembly 601. As with the example embodiments described in connection with FIGS. 3-5, a display panel or image 602 provides an image. This image traverses a first optic axis 603, is incident on a reflective surface 604, and is reflected and travels along a second optic axis 605. The second optic axis 604 is the optic axis of the lens assembly 601, and is orthogonal to the first optic axis 603. A projected image 605 from the lens assembly is transmitted to a display surface in a similar manner as described in connection with the embodiments of FIGS. 1-5. It is noted that many of the functions and elements of the example embodiments described in connection with FIGS. 1-5 are directly applicable to the example embodiment of FIGS. 6 and 7 and are not repeated so as to not obscure the description of these example embodiments.

FIG. 7 shows the projection lens assembly 600 with the lens assembly 601 rotated by an angle (Φ) 701. The rotation angle 701 shows the degree of rotation 703 of the lens assembly 601 relative to its original orientation 702.

As described in connection with the example embodiments of FIGS. 1-5, the projection lens assembly 600 provides versatility because a variety of display devices may incorporate one projection lens system.

It is noted that the use of tubes for housing the various elements of the assembly 600 and the use of a base or mount with a rotational device as described previously may be applied to the present example embodiments.

FIG. 8 shows a projection optical system connected to a base in accordance with an example embodiment. The second lens assembly 303 described in connection with the example embodiment of FIG. 3 is shown. Alternatively, this may be the lens assembly 601 described in connection with the example embodiment of FIG. 6. The projection optical system is connected to and rotates relative to a base 105. To wit, a tube 801 is connected to the base 105, and the second lens assembly 303 is adapted to rotate in a manner shown by a comparison of the orientation of the second lens assembly 303 of FIG. 8 with its orientation in FIG. 9. As described previously, the rotation is about a first optic axis (not viewable in FIGS. 8 and 9). Moreover, it is noted that in accordance with an example embodiment described previously, a second tube 802 may be used to house elements.

The example embodiments having been described in detail, it is clear that modifications of the invention will be apparent to one having ordinary skill in the art having had the benefit of the present disclosure. Such modifications and variations are included in the scope of the appended claims.

1. An optical system for a projection display device, comprising:
a first lens group having a first optic axis; and
a second lens group having a second optic axis, wherein the second lens group is adapted to rotate about the first optic axis.

2. The optical system of claim 1, including a display panel that provides an image to the first lens group and along the first optic axis.

3. The optical system of claim 2, wherein the display panel is a liquid crystal panel of a liquid crystal imaging system.

4. The optical system of claim 3, wherein the liquid crystal panel is a liquid crystal on silicon (LCOS) device.
4a. The optical system of claim 2, wherein the display panel is a DMD device.
4b. The optical system of claim 1, wherein the projection display is a scanning laser beam projection system

5. The optical system of claim 1, wherein the optical system is disposed over a base.

6. The optical system of claim 5, wherein the rotation is relative to the base.

7. The optical system of claim 2, wherein the image is projected onto a rear mirror of a rear projection display device.

8. The optical system of claim 1, wherein the rotation is counterclockwise or clockwise.

9. The optical system of claim 1, wherein the first lens assembly is disposed in a first tube and the second lens assembly is disposed in a second tube.

10. The optical system of claim 1, wherein both the first and second lens assemblies are disposed in a tube.

11. A rear projection display device which comprises the optical system as recited in claim 1.

12. An optical system for a projection display device, comprising:
a first optic axis; and
a lens group having a second optic axis,
wherein the lens group is adapted to rotate about the first optic axis.

13. The optical system of claim 12, including a display panel, which provides an image to the lens group and along the first optic axis.

14. The optical system of claim 12, wherein the display panel is a liquid crystal panel of a liquid crystal imaging system.

15. The optical system of claim 14, wherein the liquid crystal panel is a liquid crystal on silicon (LCOS) device.

16. The optical system of claim 12, wherein the display panel is a DMD device.

17. The optical system of claim 12, wherein the optical system is disposed over a base.

18. The optical system of claim 17, wherein the rotation is relative to the base.

19. The optical system of claim 2, wherein the image is projected onto a rear mirror of a rear projection display device.

20. The optical system of claim 12, wherein the rotation is counterclockwise or clockwise.

21. A rear projection display device including the optical system of claim 12.

22. A projection system according to claim 12, where the first optic axis is orthogonal to the second optic axis.
